(19) United States
(12) Patent Application Publication
(10) Pub. No.: US 2012/0124359 A1
(43) Pub. Date: May 17, 2012

(54) PROGRAM PROCESSING APPARATUS

(75) Inventors: Takahiro Miomo, Higashiosaka-shi (JP); Shinya Nagayasu, Kizugawa-shi (JP)

(73) Assignee: Sanyo Electric Co., Ltd., Osaka (JP)

(21) Appl. No.: 13/289,438

(22) Filed: Nov. 4, 2011

(30) Foreign Application Priority Data
Nov. 11, 2010 (JP) 2010-252642

(51) Int. Cl. G06F 15/177

(52) U.S. Cl. 713/2

(57) ABSTRACT

A program processing apparatus includes an internal memory An internal memory is arranged to save a first program for activating a target program. A first designator designates the first program in response to a first manipulation in a state that an external memory which saves a second program for updating the internal memory is removed and the first program is saved in the internal memory. A second designator designates the second program in response to a second manipulation in a state that the external memory is attached. An executer executes the program designated by one of the first designator and the second designator.

### CROSS REFERENCE OF RELATED APPLICATION

The disclosure of Japanese Patent Application No. 2010-252642, which was filed on Nov. 11, 2010, is incorporated herein by reference.

### BACKGROUND OF THE INVENTION

1. Field of the Invention

The present invention relates to a program processing apparatus, and more particularly, relates to a program processing apparatus which updates a program saved in an internal memory by a program saved in an external memory.

2. Description of the Related Art

According to this type of an apparatus, when a memory card in which a program and its version information are saved is connected to an external connector, a flash ROM in which version information different from the version information of the program saved in the memory card is saved is specified from among a plurality of flash ROMs. The program saved in the memory card is written into the flash ROM specified in this way. As a result, it is possible to reduce a time period necessary to download the program.

However, in the above-described apparatus, a process for updating the program saved in the flash ROM is not utilized in other processes, and a processing performance is limited.

### SUMMARY OF THE INVENTION

A program processing apparatus according to the present invention comprises: an internal memory arranged to save a first program for activating a target program; a first designator which designates the first program in response to a first manipulation in a state that an external memory which saves a second program for updating the internal memory is removed and the first program is saved in the internal memory; a second designator which designates the second program in response to a second manipulation in a state that the external memory is attached; and an executer which executes a program designated by one of the first designator and the second designator.

According to the present invention, a computer program embodied in a tangible medium, which is executed by a processor of a program processing apparatus including an internal memory arranged to save a first program for activating a target program, the computer program comprises: a first designating step of designating a first program in response to a first manipulation in a state that an external memory which saves a second program for updating the internal memory is removed and the first program is saved in the internal memory; a second designating step of designating a second program in response to a second manipulation in a state that the external memory is attached; and an executing step of executing a program designated by one of the first designating step and the second designating step.

According to the present invention, a program processing method, which is executed by a program processing apparatus including an internal memory arranged to save a first program for activating a target program, the method comprises: a first designating step of designating a first program in response to a first manipulation in a state that an external memory which saves a second program for updating the internal memory is removed and the first program is saved in the internal memory; a second designating step of designating a second program in response to a second manipulation in a state that the external memory is attached; and an executing step of executing a program designated by one of the first designating step and the second designating step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative diagram showing one example of a mapping state of an NAND-type flash memory;

FIG. 4 is an illustrative diagram showing one example of a mapping state of an eMMC device;

FIG. 5 is a flowchart showing one portion of behavior of a CPU applied to the embodiment in FIG. 2; and

FIG. 6 is a flowchart showing another portion of the behavior of the CPU applied to the embodiment in FIG. 2.

### DETAILED DESCRIPTION OF THE PREFERRED EMBODIMENTS

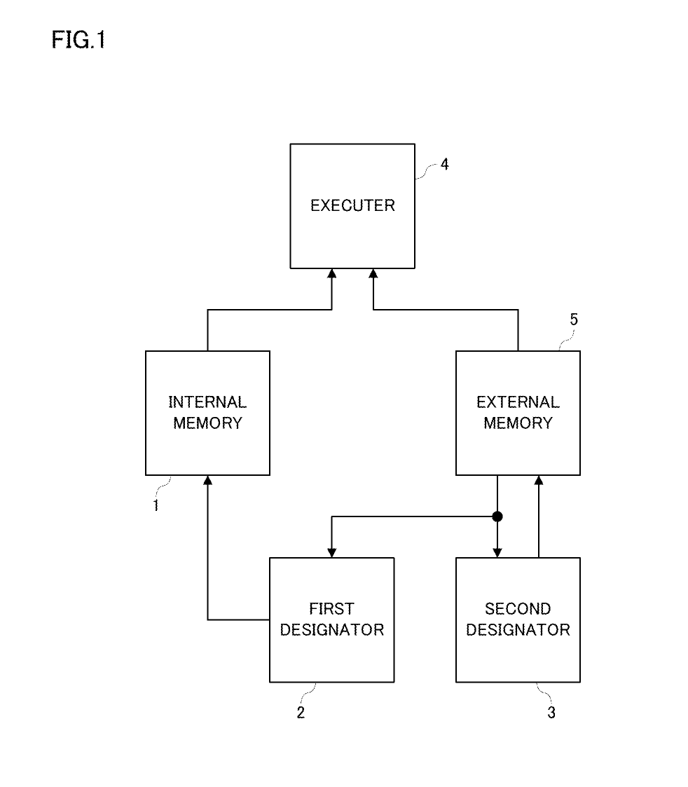

With reference to FIG. 1, a program processing apparatus of one embodiment of the present invention is basically configured as follows: An internal memory 1 is arranged to save a first program for activating a target program. A first designator 2 designates the first program in response to a first manipulation in a state that an external memory 5 which saves a second program for updating the internal memory 1 is removed and the first program is saved in the internal memory 1. A second designator 3 designates the second program in response to a second manipulation in a state that the external memory 5 is attached. An executer 4 executes the program designated by one of the first designator 2 and the second designator 3.

A difference in execution mode of the executer 4 arises by changing a designated program depending on attachment/non-attachment of the external memory 5. As a result, it is possible to partially commonalize a process for updating the internal memory 1 and a process for activating the target program and improve a processing performance.

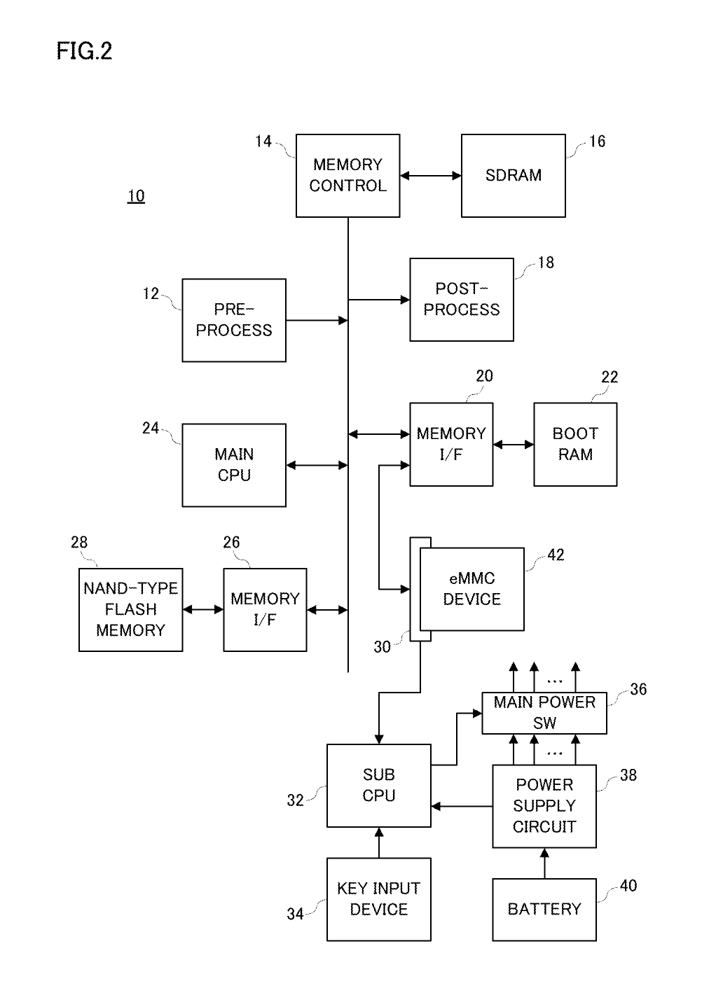

With reference to FIG. 2, a data processing apparatus 10 according to this embodiment includes a power supply circuit 38. The power supply circuit 38 generates a plurality of direct current power supplies, each of which shows a different voltage value, based on a battery 40. One portion of the plurality of the generated direct current power supplies is directly applied to a sub CPU 32, and another portion of the plurality of the generated direct current power supplies is applied to the entire system via a main power switch 36. Therefore, the sub CPU 32 is activated all the times, whereas the elements configuring the entire system are activated/stopped depending on the ON/OFF state of the main power switch 36.

It is noted that according to this embodiment, the “entire system” means a pre-processing circuit 12, a memory control circuit 14, an SDRAM 16, a post-processing circuit 18, a memory I/F 20, a boot RAM 22, a main CPU 24, a memory I/F 26, and a slot 30.

When a power-on manipulation is performed by a key input device 34, the sub CPU 32 determines whether or not a manipulation state of a key arranged in the key input device 34 is a specific state and whether or not an eMMC (embedded MultiMedia Card) device 42 is attached to the slot 30.

If the key manipulation state is a specific state and the eMMC device 42 is attached to the slot 30, the sub CPU 32 sets an eMMC boot trigger to an H level. On the other hand, if the key manipulation state is a state other than the specific state or the eMMC device 42 is removed from the slot 30, the sub CPU 32 sets the eMMC boot trigger to an L level. Herein, the eMMC boot trigger indicating the H level corresponds to a request to read out an IPL_nand (IPL: Initial Program Loader) saved in an NAND-type flash memory 28, and the eMMC boot trigger indicating the L level corresponds to a request to read out an IPL_emmc saved in the eMMC device 42.

Upon completion of the level setting of the eMMC boot trigger, the sub CPU 32 sets the main power switch 36 to an ON state. As a result, the entire system is activated. Thereafter, if a power-off manipulation is performed by the key input device 32, the sub CPU 32 sets the main power switch 36 to an OFF state. As a result, the entire system stops.

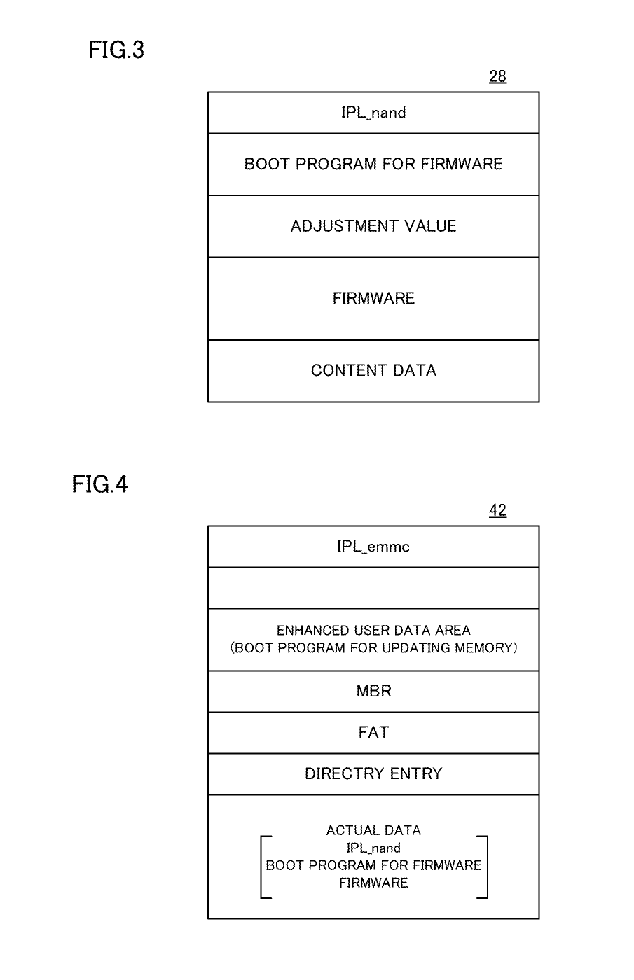

With reference to FIG. 3, a flash memory 28 stores an IPL_nand, a firmware-use boot program, an adjustment value, firmware, and content data. The IPL_nand corresponds to information for loading the firmware-use boot program. The firmware-use boot program corresponds to a program for activating the firmware. The adjustment value corresponds to a parameter value referenced by the firmware. The content data corresponds to data created by executing the firmware.

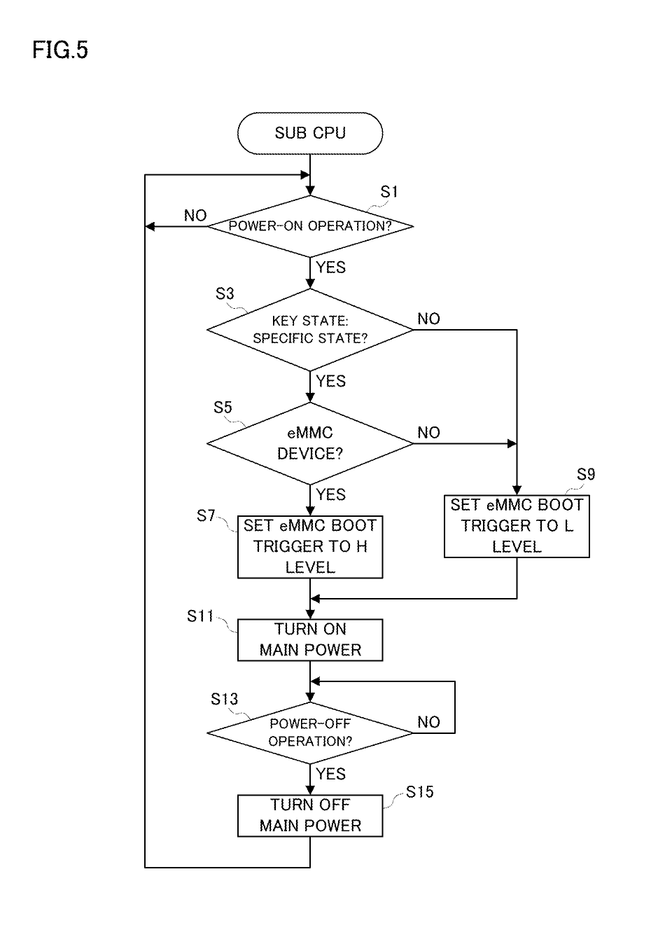

With reference to FIG. 4, the eMMC device 42 adopts an FAT file system, stores an IPL_emmc, a memory updating-use boot program, an MBR (Master Boot Record), an FAT (File Allocation Table), and a directory entry, as management data, and stores the IPL_nand, the firmware-use boot program, and the firmware, as actual data.

The IPL_emmc corresponds to information for loading the memory updating-use boot program The memory updating-use boot program corresponds to a program for replicating the IPL_nand, the firmware-use boot program, and the firmware into the flash memory 28. It is noted that the memory updating-use boot program is stored in an enhanced user data area.

Returning to FIG. 2, the memory IT 20 activated by the power-on manipulation detects a level of the eMMC boot trigger set by the sub CPU 32 and executes a process different depending on the detected level according to the following procedure.

If the eMMC boot trigger is at an L level, the memory I/F 20 reads out the IPL_nand from the flash memory 28 through the memory LT 26 and writes the read-out IPL_nand into the boot RAM 22.

On the other hand, if the eMMC boot trigger is at an H level, the memory I/F 20 reads out the IPL_emmc from the eMMC device 42 through the memory IT 20 and the slot 30 and writes the read-out IPL_emmc into the boot RAM 22.

In addition, the main CPU 24 activated by the power-on manipulation executes the following process so as to load the boot program corresponding to the IPL housed in the boot RAM 22.

If the IPL housed in the boot RAM 22 is the IPL_nand, the main CPU 24 reads out the firmware-use boot program saved in the flash memory 28 through the memory IT 26 and writes the read-out firmware-use boot program into the SDRAM 16 through the memory control circuit 14.

On the other hand, if the IPL housed in the boot RAM 22 is the IPL_emmc, the main CPU 24 reads out the memory updating-use boot program saved in the eMMC device 42 through the slot 30 and writes the read-out memory updating-use boot program into the SDRAM 16 through the memory control circuit 14.

Thereafter, the main CPU 24 executes the boot program loaded on the SDRAM 16.

If the loaded boot program is the firmware-use boot program, the firmware saved in the flash memory 28 is activated. As a result, the pre-processing circuit 12 and the post-processing circuit 18 are operated according to control of the firmware, and moreover, content data created by this operation is saved in a designated partition of the flash memory 28.

On the other hand, if the loaded boot program is the memory updating-use boot program, the flash memory 28 is updated. The IPL_nand, the firmware-use boot program, and the firmware saved in the eMMC device 42 are replicated into the designated partition of the flash memory 28 by the memory updating-use boot program.

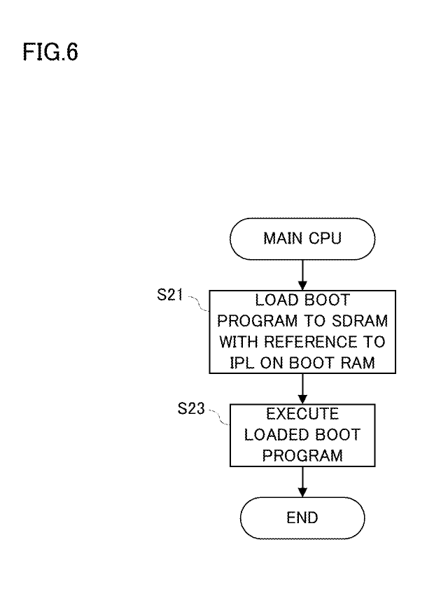

The sub CPU 32 executes a process according to a flowchart shown in FIG. 5. In addition, the main CPU 24 executes a process according to a flowchart shown in FIG. 6.

With reference to FIG. 5, in a step S1, it is determined whether or not the power-on manipulation has been performed. When the determination result is updated from NO to YES, it is determined whether or not the key manipulation state of the key input device 34 is a specific state in a step S3, and it is determined whether or not the eMMC device 42 is attached to the slot 30 in a step S5.

If the determination result in the step S3 and the determination result in the step S5 are both YES, the process advances to a step S7 so as to set the eMMC boot trigger to an H level. On the other hand, at least one of the determination result in the step S3 and the determination result in the step S5 is NO, the process advances to a step S9 so as to set the eMMC boot trigger to an L level. By the process in the step S7, it is requested to read out the IPL_nand and by the process in the step S9, it is requested to read out the IPL_emmc.

Upon completion of the process in the step S7 or the step S9, the main power switch 36 is set to the ON state in a step S11. As a result, the entire system is activated. The memory I/F 20 transfers the IPL_nand from the flash memory 28 to the boot RAM 22 in response to the eMMC boot trigger having an H level and transfers the IPL_emmc from the eMMC device 42 to the boot RAM 22 in response to the eMMC boot trigger having an L level.

In a step S13, it is determined whether or not the power-off manipulation has been performed. If the determination result is updated from NO to YES, the main power switch 36 is set to the OFF state in a step S15. As a result, the entire system stops. Upon completion of the process in the step S15, the process returns to the step S1.

With reference to FIG. 6, in a step S21, the boot program that complies with the IPL set to the boot RAM 22 is loaded on the SDRAM 16. Therefore, if the IPL on the boot RAM 22 is the IPL_nand, the firmware-use boot program saved in the flash memory 28 is loaded on the SDRAM 16. On the other hand, if the IPL on the boot RAM 22 is the IPL_emmc, the memory updating-use boot program saved in the eMMC device 42 is loaded on the SDRAM 16.

In a step S23, the loaded boot program is executed. Therefore, if the loaded boot program is the firmware-use boot program, the firmware housed in the flash memory 28 is activated, and the pre-processing circuit 12 and the post-processing circuit 18 are operated according to the firmware. On the other hand, if the loaded boot program is the memory updating-use boot program, the flash memory 28 is updated. Specifically, the IPL_nand, the firmware-use boot program, and the firmware housed in the eMMC device 42 are replicated into the designated partition on the flash memory 28.

As understood from the description above, the flash memory 28 saves the firmware-use boot program, and the eMMC device 42 saves the memory updating-use boot program. The sub CPU 32 determines whether or not the eMMC device 42 is attached to the slot 30 (S5), and designates the firmware-use boot program based on a negative determination result (S9) while the sub CPU 32 designates the memory updating-use boot program based on a positive determination result (S7). The main CPU 24 executes the boot program designated in this manner (S21 to S23). As a result, the firmware is activated in response to designation of the firmware-use boot program, and the flash memory 28 is updated in response to designation of the memory updating-use boot program.

Thus, when the eMMC device 42 is in a non-attachment state, the firmware-use boot program saved in the flash memory 28 is designated, On the other hand, when the eMMC device 42 is in an attachment state, the memory updating-use boot program saved in the eMMC device 42 is designated. If the designated program is the firmware-use boot program, the firmware is activated. If the designated program is the memory updating-use boot program, the flash memory 28 is updated. That is, a difference in subsequent processing mode arises by changing the designated boot program depending on attachment/non-attachment of the eMMC device 42. As a result, the updating process of the flash memory 28 and the activating process of the firmware can be partially commonalized, and this serves to improve the processing performance.

It is noted that in this embodiment, a different boot program is loaded depending on the level of the boot trigger. However, the trigger to be noticed is not limited to the boot trigger, and the program to be loaded is not limited to the boot program.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A program processing apparatus, comprising:
an internal memory arranged to save a first program for activating a target program;
a first designator which designates the first program in response to a first manipulation in a state that an external memory which saves a second program for updating said internal memory is removed and the first program is saved in said internal memory;
a second designator which designates the second program in response to a second manipulation in a state that the external memory is attached; and
an executer which executes a program designated by one of said first designator and said second designator.

2. A program processing apparatus according to claim 1, wherein the target program corresponds to firmware, and each of said first program and said second program corresponds to a boot program.

3. A program processing apparatus according to claim 2, wherein said internal memory is arranged to further save first load information for loading the first program, the external memory further saves second load information for loading the second program, a process of said first designator includes a process of requesting to read out the first load information, and a process of said second designator includes a process of requesting to read out the second load information.

4. A program processing apparatus according to claim 3, wherein said executer includes a loader which loads a program corresponding to the load information read out by one of said first designator and said second designator and a processor which executes a process that complies with the program loaded by said loader.

5. A program processing apparatus according to claim 1, wherein the external memory further saves the first program, and the second program corresponds to a program for transferring the first program from the external memory to said internal memory.

6. A program processing apparatus according to claim 5, wherein said internal memory is arranged to further save the target program, the external memory further saves the target program, and the second program corresponds to a program for further transferring the target program from the external memory to said internal memory.

7. A program processing apparatus according to claim 1, wherein said first designator and said second designator executes a process under a first CPU, and said executer executes a process under a second CPU.

8. A computer program embodied in a tangible medium, which is executed by a processor of a program processing apparatus including an internal memory arranged to save a first program for activating a target program, the computer program comprising:
a first designating step of designating a first program in response to a first manipulation in a state that an external memory which saves a second program for updating said internal memory is removed and the first program is saved in said internal memory;
a second designating step of designating a second program in response to a second manipulation in a state that the external memory is attached; and
an executing step of executing a program designated by one of said first designating step and said second designating step.

9. A program processing method, which is executed by a program processing apparatus including an internal memory arranged to save a first program for activating a target program, the method comprising:
a first designating step of designating a first program in response to a first manipulation in a state that an external memory which saves a second program for updating said internal memory is removed and the first program is saved in said internal memory;
a second designating step of designating a second program in response to a second manipulation in a state that the external memory is attached; and
an executing step of executing a program designated by one of said first designating step and said second designating step.
